(19) United States
(12) Patent Application Publication
(10) Pub. No.: US 2017/0221114 A1
(43) Pub. Date: Aug. 3, 2017

(54) SYSTEM for GENERATING and IDENTIFYING an OCR FINGERPRINT

(71) Applicants: Scott R. COPELAND, Pasadena, TX (US); Suzanne J. DuBose, Houston, TX (US)

(72) Inventors: Scott R. COPELAND, Pasadena, TX (US); Suzanne J. DuBose, Houston, TX (US)

(21) Appl. No.: 15/476,784

(22) Filed: Mar. 31, 2017

Related U.S. Application Data
(63) Continuation-in-part of application No. 14/824,400, filed on Aug. 12, 2015.
(60) Provisional application No. 62/354,803, filed on Jun. 26, 2016.
(60) Provisional application No. 62/194,796, filed on Jul. 20, 2015.

(51) Int. Cl. G06Q 30/06; G06K 9/34

(52) U.S. Cl. CPC G06Q 30/0603; G06K 9/344; G06Q 30/0613; G06K 2209/01; G06Q 30/0633

(57) ABSTRACT

Disclosed is a system enabling the participation of a third-party computer program in a shopping activity between a vendor and consumer. The system is a software application that resides in part on a consumer smart device and in part on a publisher's system server. The present system enables the consumer smart device to transform a published advertising image from a hardcopy (magazine) page to a digital OCR fingerprint representative of the hardcopy page, and to sent the OCR fingerprint to the publisher's system server. The OCR fingerprint is compared against a database of other similarly generated OCR fingerprints of hardcopy pages from the magazine, including the advertising page of interest, for a match. Upon finding a suitable match, the vendor and item information for the items for sale on the advertising page are displayed on the smart device, enabling the consumer to browse the information and implement a purchase.

Continuity Data: The present application claims the benefit of prior filed U.S. Provisional Patent Application, Ser. No. 62/354,803 filed 26 Jun. 2016 to which the present application is a U.S. non-provisional utility application; and of prior filed U.S. Ser. No. 14/824,400 filed 12 Aug. 2015, to which the present application is a Continuation-in-Part application, and which prior applications are incorporated herein by reference in their entirety.

### FIELD OF THE INVENTION

The present invention is in the field of data processing, wherein an electrical apparatus and its corresponding methods perform data processing operations utilized for cost/price determination and the processing of consumer financial data (US Class 705/subclass 1.1). Specifically, the present invention relates to electronic shopping (subclass 26.1), and subject matter is drawn to a computerized system which responds to shoppers, and enables a shopper to investigate, specify, order, and purchase one or more items for sale or trade using a “smart” device configured to include communications functionality for the exchange of information concerning the one or more specified items. More specifically, the present invention is drawn to subject matter configured to facilitate and support a third-party computer program's participation in a shopping activity between a shopper and a vendor (subclass 26.41).

### SUMMARY OF THE INVENTION

The invention uses an OCR to extract text from a printed page, find several points of correlation and create a fingerprint, which can be used by the publisher to determine the relevant page and take an appropriate action based on the needs of the inquirer. In one embodiment, the invention includes a user smart device having a camera that captures hardcopy image data and transforms the image data using an OCR process into a User image fingerprint. The image fingerprint comprises points of correlation and unique topographical data created from them. An example is the relative distance between several words identified by the OCR image fingerprinting process. The image fingerprint is sent to a publisher server where it is compared to fingerprints established on the publisher server from pages contained in the publishers printed materials. The publisher server's e-Catalogue database uses multiple processes against the fingerprint to identify a correct or closest match. The match result(s) are returned to the User device.

The hardcopy Vendor pages of interest from a published magazine are each scanned to capture a page image, the captured image is fully or partially fingerprinted, and added to an e-Catalogue Database. The partial fingerprinting allows the system to do less work to achieve a match result. An appropriate match result may be found early in the multi-process identification logic, and therefor eliminate a need for further match processing. The result for some of the matching process (which steps derive from the points of correlation) cannot be determined in advance, because discrepancies can occur if the User Device is unable to capture a perfect image, or if OCR read of the page in question is faulty. This could be caused by light glare, torn page, improper use of the User device, etc. Hence, some of the fingerprinting elements are based on pseudo-elements, which eliminate the need for a perfect image or OCR read. This method allows the Publisher software application to use a less than perfect incoming fingerprint from the User device, and to compare it against its e-Catalogue database pseudo-data to find an appropriate match with a high degree of accuracy.

### BRIEF DESCRIPTION OF THE DRAWINGS

FIG. 1 is a schematic drawing showing an overview of the system which is comprised of a Consumer Device running a consumer software application (Consumer App) communicating via a com-link with a System Server running a server software application (Server App), which communicates with one or more Vendors.

FIG. 2 is a schematic drawing showing a plurality of Vendors supplying product and services information to the System Server to be integrated into the Server App's database.

FIG. 3 is a flowchart exemplifying a consumer registration process being negotiated between a consumer device and a system server.

FIG. 4 is a schematic drawing illustrating the consumer app on a consumer device instructing the camera on the consumer device to capture a digital image of a hardcopy image (e.g., a magazine page in this example), run an optical recognition process (“OCR” for example) on the digital image and send the resultant data to the server app via a network connection.

FIG. 5 is a schematic drawing illustrating the consumer app and the server app coordinating to give the consumer app information from the system database relevant to the latest OCR query.

FIG. 6a is a flowchart exemplifying a logic process for purchasing items in the “shopping cart” feature of the consumer software app.

FIG. 6b is an illustration showing an order placed by a consumer being parsed by the server app and sent to one or more vendors.

FIG. 6c is an illustration showing the vendor sending the order verification to the server app and the server app passing the information to the consumer app.

FIG. 7 is a flow chart illustrating a transformation process starting with a hardcopy page (e.g., from a printed magazine) and using its image content to reference information in an e-catalogue database regarding an item advertised on the hardcopy page.

FIG. 8 is a flow chart illustrating a method for a third-party computer program's facilitation of a shopping activity between a vendor and a consumer over a global computer network.

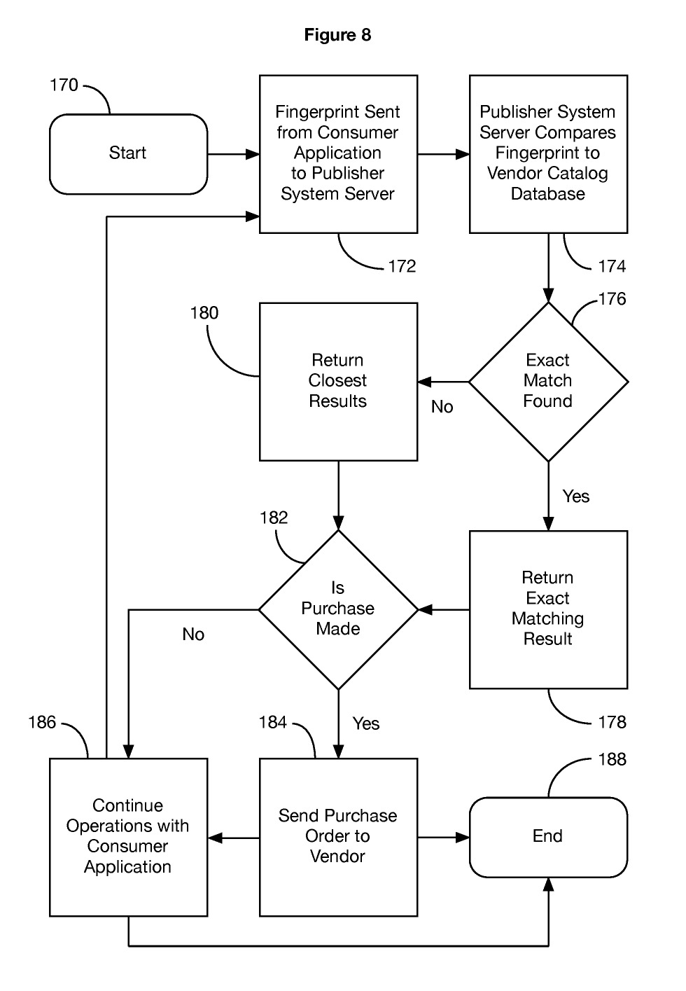

FIG. 9a is an illustration showing an overview of the system comprising of a User Device, a Publisher Server and a Vendor Item.

FIG. 9b is an illustration of a User Device capturing a page image, deriving a Fingerprint from the captured page image, and sending the Fingerprint to the Publisher Server.

FIG. 10 is an illustration of the User device capturing a page, applying an OCR process to the page, establishing the fingerprint data and sending the fingerprint to the publisher server.

FIG. 11 is an illustration showing how the system determines the Y axis value for the points of correlation.

FIG. 12 is an illustration showing how the system determines the X and Y polarity values for each of the points of correlation.

FIG. 13 is an illustration showing how the system determines the X and Y values based on the pseudo-edges.

FIG. 14 is an illustration showing how the system determines the size data for each of the points of correlation in the fingerprint.

FIG. 15 is an illustration of the User device communicating with the publisher server for the purpose of sending and receiving data such as receiving fingerprint results and exchanging purchase details and confirmations.

FIG. 16 is a flowchart illustrating the logic used by the system to determine results for a fingerprint search/matching process.

### ELEMENT REFERENCE NUMBERS

10 optical recognition system
12 consumer smart device
14 consumer e-catalogue application, including software for transforming HCP (“hardcopy page”) content
18 consumer com-link
20 publisher system server
22 publisher software application
26 point correlation software
30 global communications network
32 vendor com-link
34 vendor
40 consumer device camera
44 image transforming/fingerprinting software
46 HCP digital fingerprint
50 system database
52 vendor/item fingerprint
70 hardcopy page
74 advertised item
100 start registration process
102 create consumer ID & password
104 input (real) consumer name & info
106 run payment sub-process
108 run reg. confirmation sub-process
110 end registration process
120 start purchase process (e.g., load and display “shopping cart” software or other vendor specific purchasing process)
122 send purchase information to publisher server e-catalog application
124 determine vendor(s)
126 retrieve payment & shipping information
128 output purchase order to vendor(s)
130 end purchase process, send order confirmation
150 start transformation process
152 transformation HCP process
154 generate HCP fingerprint
156 match HCP fingerprint to e-catalogue database
158 retrieve vendor/item information from match
160 display vendor/item information
162 end transformation process
170 start assisted shopping process
172 transform HCP content to HCP fingerprint & send to server
174 compare HCP fingerprint to e-catalogue database for HCP fingerprint matches
176 process match results for vendor/item information
178/180 display matching vendor/item information
182 detect a purchase decision
184 initiate vendor/item purchase process
186 continue shopping currently displayed vendor/item information
188 end assisted shopping process
205 Captured Media Image
210 User Image Fingerprint, User Device generated
212 Publisher Item Fingerprint, Publisher generated
214 Vendor Item
216 Companion/Digitizer Software Application
218 OCR software application
220 Camera
225 Hardcopy Page
230 Network Connection
235 Global Communications Network
240 Publisher Server
245 Publisher Software Application
250 e-Catalog Database
255 User Device
260 User Software Application
265 Y-Coordinate
270 Point of Correlation (POC)
275 Relative Coordinate
280 Pseudo-Edge Box
285 Pseudo-Edge Coordinates
290 Baseline Size
295 Relative Size
300 Fingerprint Matching Process
301 Start Matching Process
305 Match POC words to Database
310 Decision, Match Found
315 Refine Results
320 Check POC Y-Axis Data
325 Check POC Polarity Data
330 Check POC Pseudo-Edge Data
335 Check POC Size Data
340 Return Match Results
345 End Matching Process

### DESCRIPTION OF THE INVENTION

The present invention is a system and method combining hardware and software to facilitate a consumer's purchase of goods and services from a hardcopy advertising medium, such as print magazines and periodicals. The present inventive system includes a software application, part of which is resident on a system server and part of which is downloadable to a (consumer's) mobile “smart” device. The present system and method enables a consumer to use a mobile smart device to browse information and to purchase goods and services advertised in a hardcopy print medium, the enablement of which is not directly provided for in the hardcopy medium itself (e.g., there is no QR code displayed on the hardcopy page itself). In a preferred embodiment of the present System, a User is able to generate an OCR Image Fingerprint from print media/hardcopy page via the use of a User Device operating an OCR software application. The User Fingerprint generated from the hardcopy page using a: character/word relative geometric topography logic process.

The present combination of hardware and software enables a consumer's purchase of goods and services from a hardcopy advertising medium using a “smart” device enabled with image converting/transforming software. A “smart” device for use with the present system is a device such as a smart phone, a tablet-type computing device, and other personally portable computing devices, which have a built in camera and camera function. By using image converting/transforming software (like an optical character recognition program) on a consumer's smart device to analyze a hard copy image (e.g., one or more page in a magazine publication), the present inventive system determines certain information about the magazine and the specific page: e.g., publication name, date of publication, specific page numbers, vendor, etc. The publisher of the image/magazine provides an e-catalogue database on a publisher system server. The e-catalogue database provides information about the products and services on a given page (e.g., vendor, sizes, colors, description, price, availability, etc.). The system will allow the consumer to pick the item or service with its associated options and facilitate the transaction with the seller. The system will gather the associated payment method and shipping address, along with the order, and send as a complete package to the vendor.

Referring now to the drawings, the details of preferred embodiments of the present invention are graphically and schematically illustrated. Like elements in the drawings are represented by like numbers, and any similar elements are represented by like numbers with a different lower case letter suffix.

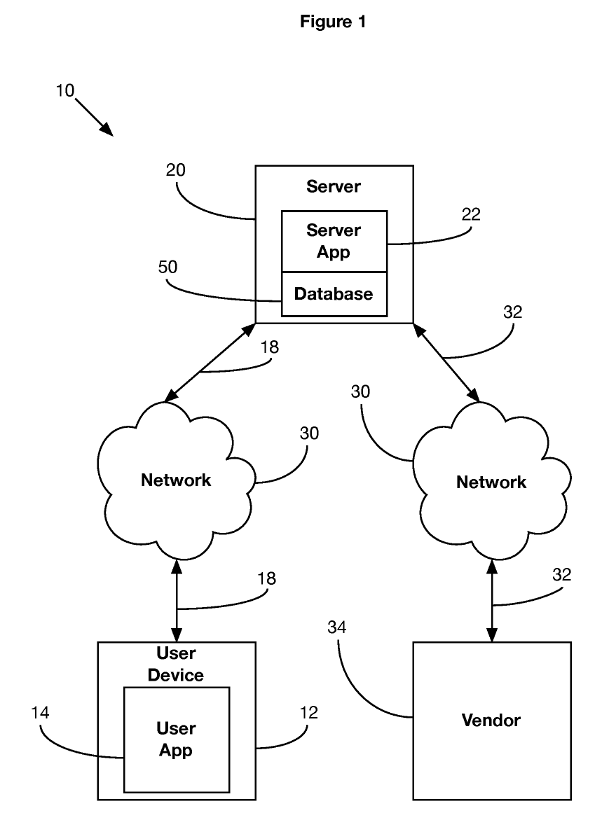

As shown in FIG. 1, the present system 10 for facilitating a shopping activity between a vendor and a consumer comprises: a mobile smart device 12 enabled with the present downloadable consumer software application 14; a publisher system server 20 running the present server e-catalog application 22, and having an e-catalog database 50. The raw content for the e-catalogue database 50 is provided to the publisher system 20 by retailors/vendors 34, for whom the publisher is a third party facilitator of a shopping transaction between a consumer and a vendor.

The figure illustrates a consumer smart device 12 running a downloadable consumer software application 14. The consumer application exchanges communications with the publisher server 20 via a network connection 18 using the smart device 12. One or more vendors 34 also exchange communications with the publisher server 20 via a network connection 32 using an appropriate network communication device (not shown). The consumer device never communicates directly with the vendor in the course of a transaction, and vice versa. All shopping transactions are handled through the third-party publisher. Communications between the consumer smart device 12, the publisher system server 20 and the vendors 34 is accomplished over a global communications network 30, e.g. the World Wide Web.

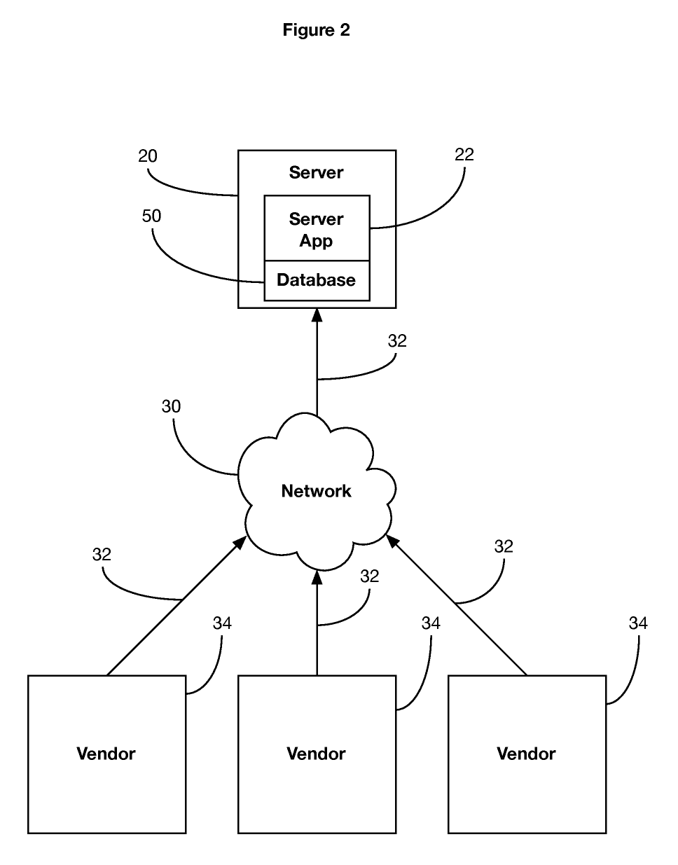

FIG. 2 exemplifies a plurality of vendors 34 supplying product and services information to the publisher system server 20 for the server e-catalog application 22 to integrate into the e-catalogue database 50. Via the network 30, the vendors 34 supply product and services information only to the publisher system 20, not directly to the consumer device 12.

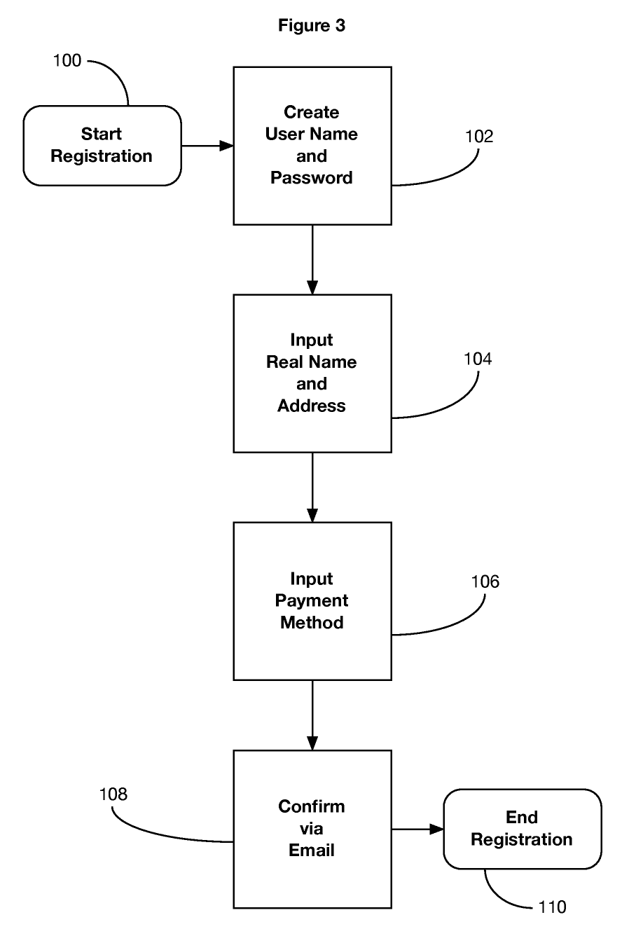

In using the present system 10, a consumer loads the consumer e-catalogue software application 14 onto the consumer's smart device 12. In the embodiment exemplified, it is intended that the consumer downloaded consumer software application 14 from an “app store” (not shown), as is known in the art. The consumer initializes (registers) use of the consumer software application 14 as is typical in the art. FIG. 3 exemplifies such a registration process, wherein the consumer installs the application 14 and starts the registration process 100. In proceeding through the registration process 100, the consumer creates a user/consumer name and password 102; can provide personal information 104; provides payment information 106 and contact information 108 before ending the registration process 110. This information is initiated at the consumer device 12 and then transmitted by the consumer software application 14 to the publisher system server for storage and access as typical for electronic consumer transactions.

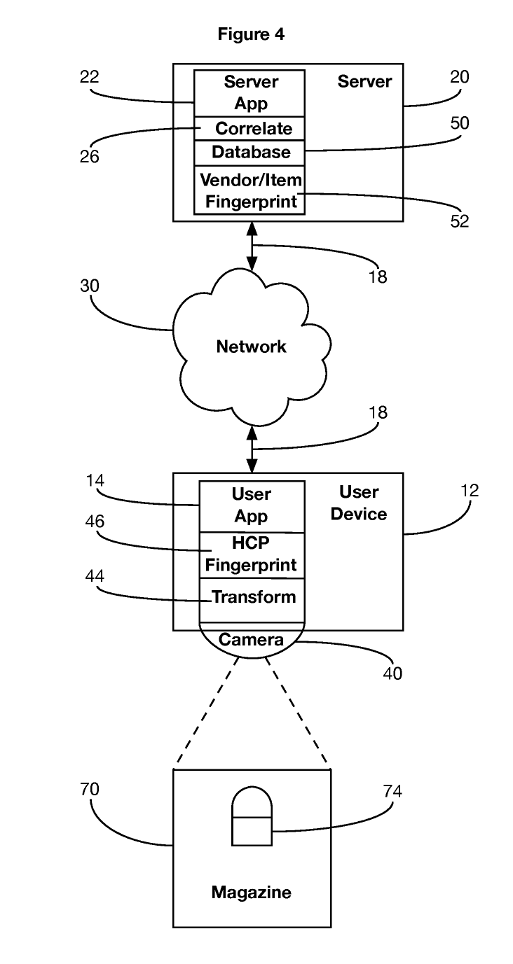

Once the consumer software application 14 is installed and activated on the smart device 12, to practice the present system, the consumer runs the consumer application 14. See FIG. 4. For the sake of illustration, upon browsing a print magazine (e.g., Cosmopolitan®) and finding an advertised item 74 on a hardcopy page 70 in the magazine (e.g., a Gucci® purse), the consumer utilizes the camera function 40 of the smart device 12 to acquire an image of the advertised item 74 from the page 70 and of the cover (not shown) of the magazine. The image transforming/fingerprinting software 44 of the consumer application 14 transforms content (e.g., alpha/numeric content, image content, image character characteristic content) of one or more of the hardcopy (advertisement & cover) pages 70 and from the transformed content generates a consumer “HCP digital fingerprint” 46. The HCP digital fingerprint 46 embodies electronic transformation of the image content of the hardcopy pages 70, including the advertised item 74 depicted on the page(s), and indicia of the source magazine (and a page number). The consumer smart device 12 then transmits the HCP digital fingerprint 46 of the transformed content 44 to the e-catalog application 22 of the publisher system server 20 for comparison against the e-catalogue database 50. It should be noted that in this example the transformed content 44 and the HCP fingerprint 46 are generated at the consumer smart device 12. However, in certain circumstances known to the ordinary skilled artisan, the present invention may practice by transmitting the transformed image content 44 to the e-catalog application 22 to have the HCP digital fingerprint 46 generated there.

The publisher system server 20 is a computer server as is understood in the current vernacular of the field and is connectable to the network 30. The publisher system server 20 hosts and runs the present publisher server e-catalog application 22 and the e-catalog database 50. Upon acquiring an HCP digital fingerprint 46 from the consumer application 14, the server e-catalog application 22 compares the HCP fingerprint 46 against the vendor/item fingerprints 52 of the e-catalogue database 50.

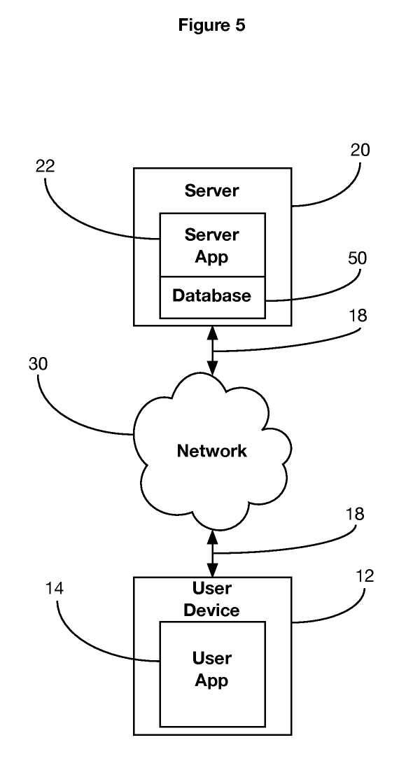

Upon finding a corresponding vendor/item e-catalogue fingerprint 52 for an item entry in the e-catalogue database 50, the item information for that entry is transmitted back to the consumer device 12 to display/presentation to the consumer the related content for that item from the e-catalog database 50. See FIG. 5. If no exact matches are found, a “points of correlation” process 26 is run by the server e-catalog application 22 to identify one or more of the most closely corresponding vendor/item fingerprints 52 that match the digital fingerprint 46. In this situation, the information for the most closely corresponding item entry/entries is transmitted back to the consumer device 12 for display/presentation to the consumer by the consumer software application 14.

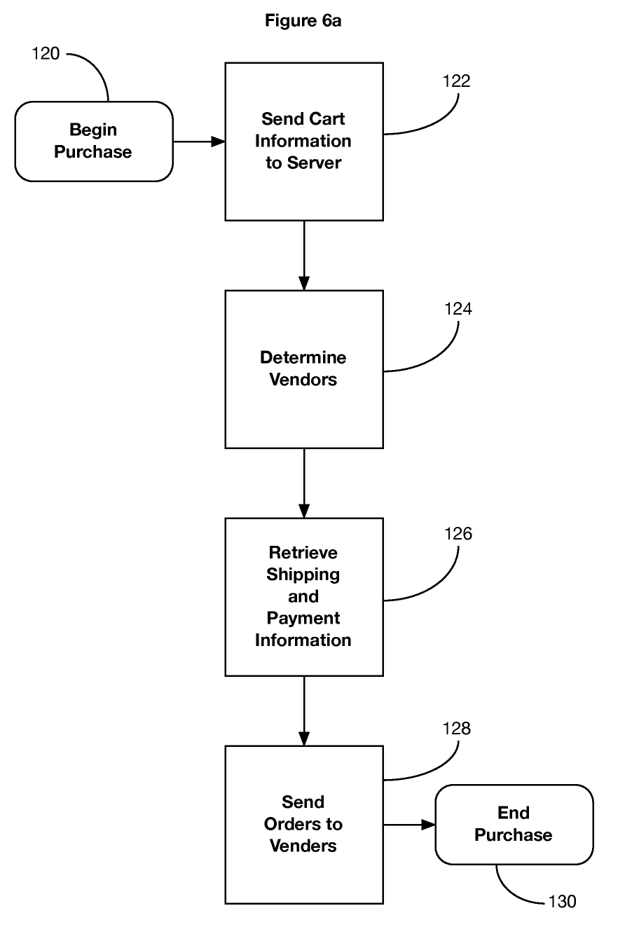

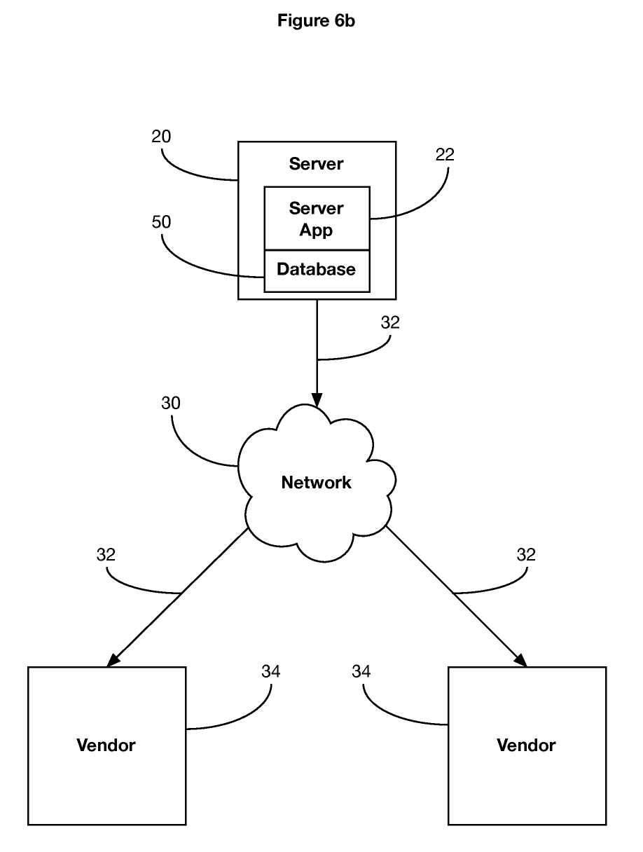

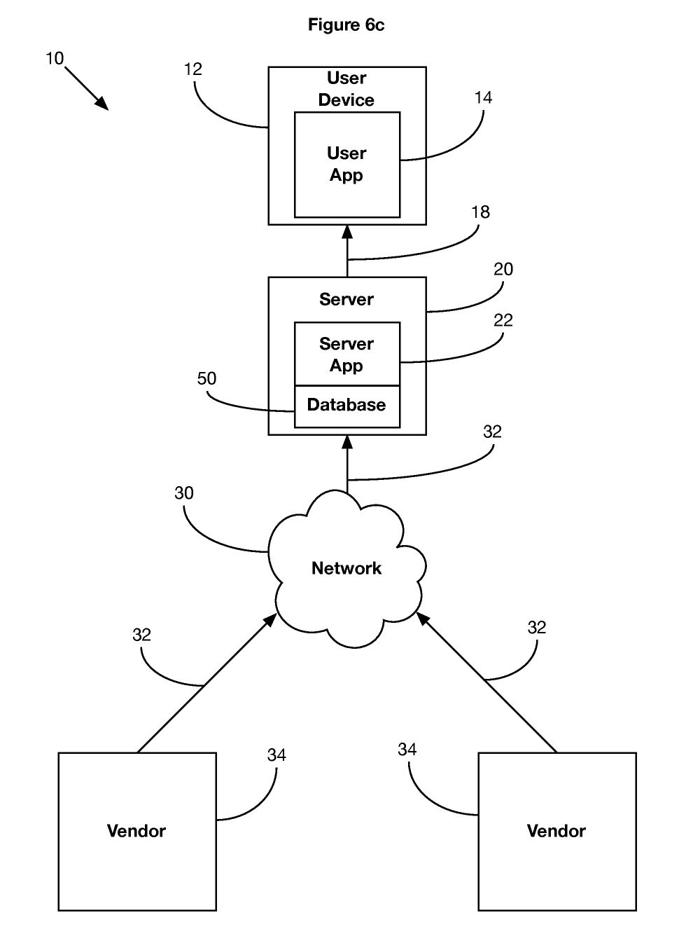

The item information is received by the consumer software application 14 and displayed on the consumer smart device 12 and can be viewed/browsed by the consumer to inform and to facilitate a purchase decision. Also displayed will be information and functionality necessary to enable the consumer to purchase the item. If the consumer desires to purchase the displayed item, the consumer software application 14 provides electronic purchase functionality as is currently known in the art. FIG. 6a exemplifies such an electronic purchase process, wherein the consumer begins the purchase process 120 and sends 122 the item purchase information to the e-catalog application 22 of the publisher system server 20. In view of the purchase information sent, the e-catalog application 22 identifies the vendor(s) 124 for the item; retrieves payment/shipping information 126 from the database 50, and prepares and sends a purchase/payment order 128 to the vendor(s). In completing the process 130, an order confirmation is sent back to the consumer software application 14 for the consumer's records.

FIG. 6b illustrates how a purchase/payment order generated by the server e-catalog application 22 is sent to one or more vendors 34. In the embodiment illustrated, the vendor 34 processes the payment order and ships the item to the consumer. Alternatively, as shown in FIG. 6c, a vendor can send the order verification to the e-catalog application 22 and the publisher system server 20 can pass the information on to the consumer software application 14 on the consumer's smart device 12.

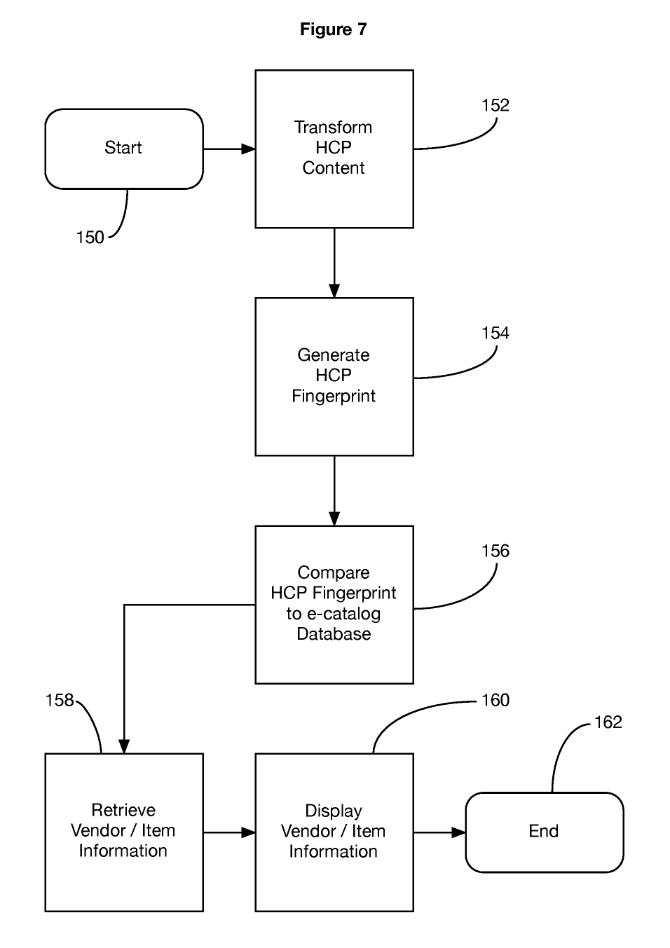

In practicing a method of the present invention wherein the system participates in a shopping activity between a vendor and a consumer (see FIGS. 7 & 8), the consumer utilizes a smart device 12 having the present downloadable consumer e-catalogue software application 14. After the consumer has identified an item for sale depicted on (say) a hardcopy magazine page 70, he/she starts the shopping process 150, 170. A first step in the shopping process 150 is to transform 152 the image content of the hardcopy magazine page 70 to a digital content/format, and then from the digital content/format to generate 154 an HCP fingerprint 46 representative of the printed content (advertisement) of the original hardcopy page 70 advertising one or more consumer items for sale. This is accomplished by HCP transforming and fingerprint generating software 44. The HCP fingerprint 46 is sent 172 to the publisher system server 20 for processing by the publisher server e-catalog application 22. In a following step, the HCP fingerprint 46 is compared 156, 174 to the vendor e-catalogue database 50 and a matching process 176 determines one or more appropriately matching vendor item/entries. If the matching process 176 finds an exact match with a vendor item/entry, the resulting vendor/item information is returned 178. Absent an exact match, one or more of the closest matching vendor/item information sets is returned 180.

Once one or more appropriately matching item/entries fingerprint is/are found, the stored vendor/item information related to the consumer item advertised on the hardcopy page 70 is retrieved 158 from the vendor e-catalogue database 50 and sent to the smart device 12. The consumer's smart device 12 then displays 160 the vendor/item information of the item/entry in the e-catalogue database 50 corresponding to the item/entry fingerprint, enabling the consumer to browse the vendor/item information and/or to purchase 182 the consumer item of the item/entry. The consumer transmits a purchase decision 120, 182 to the publisher e-catalogue software application 22, which receives, processes and outputs 184 the purchase order. The purchase order for the item for sale is output to a vendor 34 of the vendor/item entry in the vendor e-catalogue database 50 to complete 188 the shopping activity between the vendor and the consumer. Alternatively, the consumer may choose to continue shopping 186 the currently displayed vendor/item information.

Thus, the content of hardcopy advertising page 70 in a magazine can be transformed into digital content unrelated to the subject mater content of the original HCP 70. Then the digital content is used to generate a fingerprint 46. The fingerprint 46 is then usable to link to matchup with information related to the subject matter content of the HCP 70 in the vendor/item database 50. At the process end 162, 188, the shopping activity between the vendor and the consumer has been facilitated by the present system and method.

In accomplishing the e-catalogue database 50 of the present invention, a vendor supplies to the publisher system server 20 the specific information (i.e., size, color, availability, etc.) for each of their vendor/item entries in the e-catalogue database 50. The unique vendor/item e-catalogue fingerprint 52 for each vendor/item entry in the e-catalogue database 50, is generated by the publisher using basically the same transformation/fingerprinting process that the consumer smart device 12 utilizes to generate transformed HCP content 44 and thence a “digital fingerprint” 46. See above. Using the hardcopy page example of a consumer magazine, this is to say a page in the magazine having advertising content on it (i.e., items for sale), is processed by the present image transforming/fingerprinting software 44 at the publisher server to generate a digital fingerprint of the HCP the same way a consumer would with a smart device 12 loaded with the consumer e-catalogue application 14. The resulting vendor/item e-catalogue fingerprint 52 is substantially identical to the HCP fingerprint 46 that the consumer smart device would generate from the same hardcopy page, and thus can be searched and matched-up in the database 50.

The unique vendor/item e-catalogue fingerprint 52 is linked to the specific item and its information in the e-catalogue database, and allows the specific item and its information to be called up using the consumer device generated digital fingerprint 46. As the publisher of the magazine, the publisher already has access to the source of the hardcopy advertising pages of the subject magazine. Alternatively, the vendors can provide content copy of the advertising pages to the publisher.

### Purpose:

The purpose of the present system & method 10 is to assist a publisher in turning an entire hard copy print format (such as a magazine) into a virtual e-catalog. If a consumer sees an item in the magazine, the present system & method 10 enables the consumer to electronically browse additional information about the item and to purchase it. This is achieved without disturbing the magazine layout or content (i.e. no barcodes, watermarks, etc.).

### Scope:

The application will work with any pages of a magazine that display advertised products relative to which the present system is implemented. The consumer will use a “smart” device enabled with the present software to identify the magazine and a page of the magazine by taking a picture of the cover of the magazine to identify it, and of the page showing the advertised items. Alternatively, the consumer can merely enter the name and issue of the magazine to identify it. The application compares optically recognized characters from the camera image(s) with the system database to identify the items in the page image and their associated features and options. The consumer can then pick the item with its associated options and quantities and add them to a “shopping cart” feature of the application.

The application defaults to the Home screen when it is launched. A tutorial popup can launch as desired when the application is launched and provide some basic use instructions. It should be mostly (50%+) opaque and easily dismissed from the screen. The present software application is intended to provide a “shopping cart” function (see below for information on the Cart).

The Home Screen should Consist of Three Buttons;
1. Log In/Out (text on this button changes to reflect the current log status). The application will accept any consumer name and password and will send email to a fixed address.
   1.1. If there is no consumer logged in to the application then this button should read “Log In.”

1.1.1. When there is no consumer logged in the “Camera” option should be greyed out or dimmed.

1.1.2. If the consumer presses the button, the application should use a popup window dialog, with animation, asking the consumer to input a consumer name and password.

1.1.3. Authenticated log in credentials should be accepted.

1.1.4. The popup window should have a “Cancel” button which, if pressed, dismisses the popup dialog, with animation, and returns to the home screen in its default state.

1.1.5. The popup dialog should have an “OK” button which logs the consumer in with the supplied credentials and dismiss the popup window with animation;

When a consumer is logged in there should be status information (consumer name, number of payment methods available, number of purchases pending and a picture of the consumer).

1.1.6. The “Photo” button should stop being greyed or dimmed and become colorized so that it is apparent that the option is now available.

1.1.2. If there is a consumer logged in the button should say “Log Out.”

1.2.1. If the consumer presses the button, a confirmation dialog should pop up and ask if the consumer is sure that they want to log out.

1.2.1.1. The popup should have an “OK” button which dismisses the popup window, with animation, and returns the application to its default state with no consumer logged in.

1.2.1.2. The popup should have a ‘Cancel” button which dismisses the popup dialog, with animation, and returns the application to its state just before the consumer initiated the “Log Out” command
2. Camera (this button could have other names)

2.1. When this button is pressed the device should switch to camera mode.

2.2. The camera's viewfinder should have the following elements:
3. A ‘Scan’ button;

3.1. The consumer points the camera at the magazine so that the footer (magazine name, issue number/month, year and page number) is inside of the reticle in the center of the viewfinder (the orientation of the camera can be portrait or landscape (whichever orientation is determined to facilitate the required functionality) and presses the button.

3.2. The image is run through an OCR (optical character recognition) process to determine the page number.

3.2.1. If a page number is not found the reticle flashes red and the application is left in the camera's viewfinder mode so that the consumer can try again;

3.2.2. If a page number is found the Reticle flashes green (the viewfinder is left in this state for 2 seconds before leaving camera mode, returning to the Home page and using a popup window to display the relevant content of the page that was scanned. This depends on the library that will be used.

3.3. Using the database the popup from a successful scan should be populated with the relevant product information (item photo, item description, color, size and quantity), multiple items on a page are displayed inline and scrollable with their relevant information.

3.3.1. Items color, size and quantity should have a drop down menu populated with the relevant options so that the consumer may select from among them.

3.3.2. There should be a button at the end of each item's options which says “add to cart.”

The cart needs to remember which items and which options have been chosen and keep a running total on the cost so that during the purchase phase and the subsequent confirmation email will be able to inform the consumer of the final price and what was purchased

There should two buttons at the end of the list that say ‘Done” and “Checkout.” The Done button should dismiss the popup window, with animation, and return the consumer back to the camera mode so that they may scan additional pages and add more items to the Cart.

The Checkout button should replace the current popup window with a new popup window (use an animated transition) showing the contents of the Cart and a total purchase price. The new popup window should have two buttons at the bottom of the application saying “Purchase” and “Cancel.”

The Purchase button should replace the current popup window with a new popup window (using the same transition animation as before) stating that the purchase has been made and send a confirmation email to a pre-established email account.

The Cancel button should dismiss the popup window (with animation) and return the consumer to the camera's viewfinder with the contents of the cart intact, and the camera's viewfinder should be dismissed and the User Device returned to the Home screen with the contents of the cart, if any, intact.
4. Options (the options can be displayed on a full page or on a popup window with animation).

4.1. Theme option which can be toggled (current selection should be highlighted).

4.1.1. Light theme with a white background;

4.1.2. Dark theme with a black background;

4.1.3. Text and foreground colors should be modified, if needed, to maintain readability.

4.2. Text size buttons: “Small,” “Normal” (default highlighted); and “large.” These buttons should change their highlight when pressed, and resizing the text as necessary.

4.3. Payment Method button (highlight when touched)

4.4. Account Information button (highlight when touched).

4.5. Support button (highlight when touched).
5. The application should be terminated if the consumer activates the operating systems default button for exiting an application.

### OCR Fingerprinting

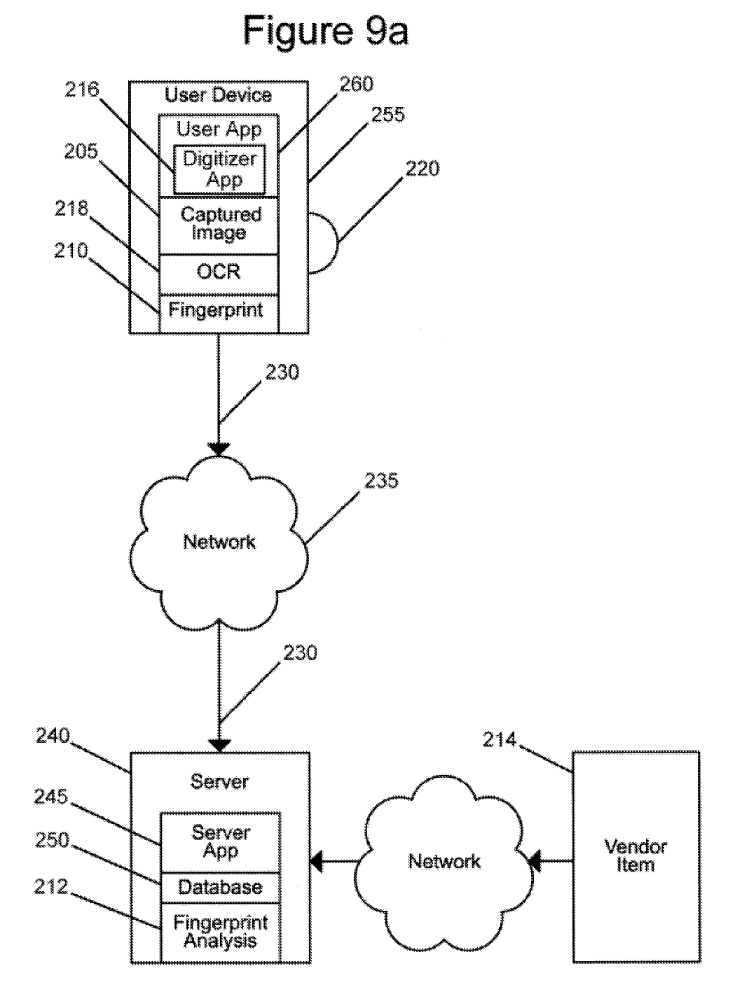

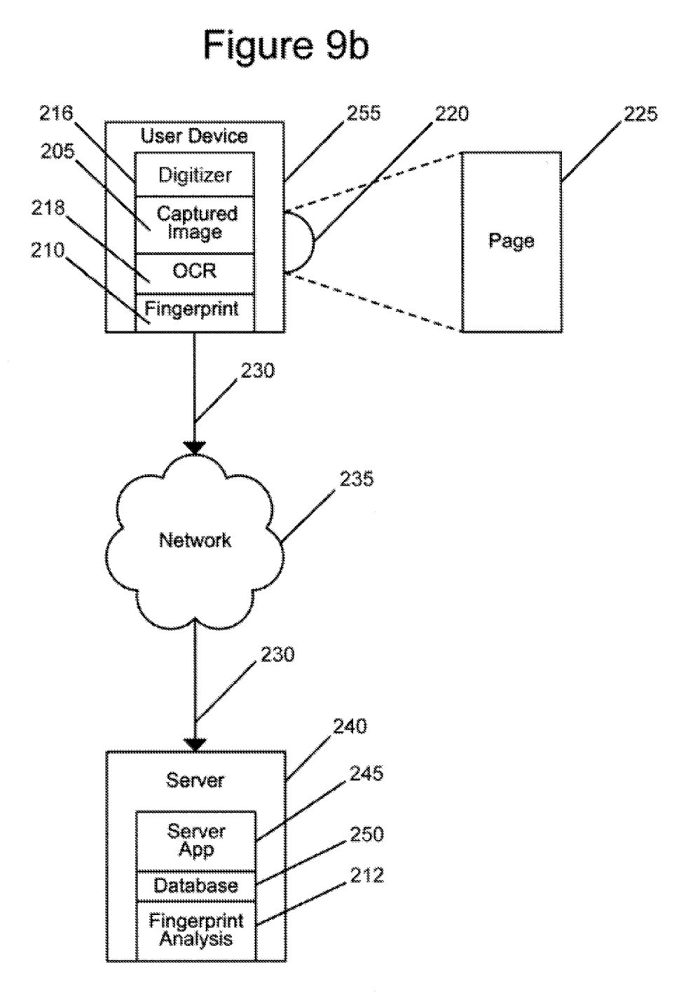

As illustrated in FIGS. 9a & 9b, the User Fingerprint 210 is sent to a Publisher Server 240, where the User Image Fingerprint 210 is used in a Fingerprint Matching Process 200 to search an e-Catalogue Database 250 for a matching Publisher Item Fingerprint 212 and associated Vendor Item 214 information in the e-Catalogue Database 250. The results 340 of the Matching Process 200 are sent back to the User Device 255 for some beneficial purpose.

An OCR fingerprint of the present invention (either a User Image Fingerprint 210 or a Publisher Item Fingerprint 212) comprises a list of words and/or characters and their topography (i.e., their relative geometric relationship to each other). The words/characters and their topography are derived from the OCR software 218 processing and the Digitizer Software 216 (including geometric analysis) processing of the Media Image 205 captured from the hardcopy page 225. The list of words/characters and their associated geometric relationships are collectively described as Points of Correlation (POC) 270.

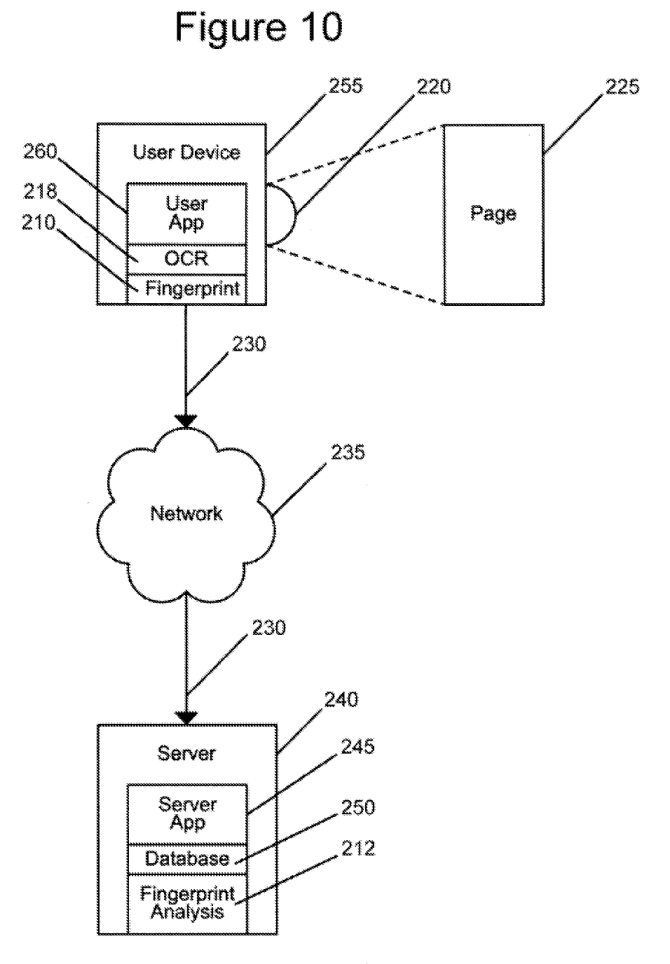

In use, the process can start from the print media of interest, e.g., a hardcopy of a printed magazine. As shown in FIG. 10, the Camera 220 of a “smart” User Device 255 is utilized to capture a Media Image 205 of a Hardcopy Page 225 (from the magazine). Typically, the content of the Hardcopy Page 225 will include pictures and text relating vendor items being advertised on that page of the magazine, and possibly express indicia of publisher, issue and page number. Then the captured Media Image 205 is processed using the Digitizer Software App (Server Companion App) 216 and OCR software 218 to extract character/word data content and their associated geometric relationships from the captured Media Image 205, and generate a User Item Fingerprint 210. The User Item Fingerprint 210 is communicated to the Publisher Software Application 245 on the Publisher Server 240. This communication can be accomplished in any of the ways known to the ordinary skilled artisan, including being sent via a Network Connection 230 across global communications network 235 (e.g., WWW).

Separately, the Publisher Software App 245 creates a Publisher Item Fingerprint 212 of the Media Image 205, see FIG. 9A. A “full” Publisher Fingerprint 212 can be derived by processing a Media Image 205 of full Hardcopy Page 225 to produce a full Points of Correlation 270 set. “Partial” Publisher Fingerprints 212 can be derived by producing partial Points of Correlation 270 sets from the Media Image 205. Partial Publisher Fingerprints 212 (partial Points of Correlation 270) are useful for improving the response time of the Fingerprint Matching Process 200 by reducing the number of points of correlation that must be processed to find a sufficiently correlating match (see below). The Publisher Software App 245 creates the “partial” Publisher Fingerprints 212 which are also entered into the e-Catalogue Database 250, along with any full Publisher Item Fingerprints. Once the e-Catalogue Database 250 is populated with fingerprints and associated vendor item data, it can facilitate matching stored Publisher Fingerprints 212 with User Item Fingerprints 210 sent to it from various Users querying for Return Results 340.

“Users” of the system refer to those end users who access the present System for the purpose of receiving expanded Vendor Item 214 information regarding the subject matter content on a hardcopy page of a printed/published media, like a magazine. As shown in FIG. 10, by utilizing a User Smart Device 255 having an attached Camera 220, the User can capture a Page 225. The User App 260 then applies an OCR 218 process and convert that data into a User Fingerprint 210. The User Item Fingerprint 210 is then sent via a Network Connection 230 across a Network 235 to the Publishers Server 240. The Server App 245 compares the User device generated User Fingerprint 210 to the Publisher Fingerprints 212 in the e-Catalogue Database 250. If a match is found the Return Results 340 are sent back to the User. If no match is found, then the Server App 245 applies additional steps to convert the initial Publisher Fingerprint 212 (used to generate the initial Return Results 340) into a more fully formed Fingerprint 213. The present System then re-analyzes the prints for a match. At the end of the matching process, whatever Publisher Fingerprints 212 are left in the Return Results 340 queue are returned to the User Device 255.

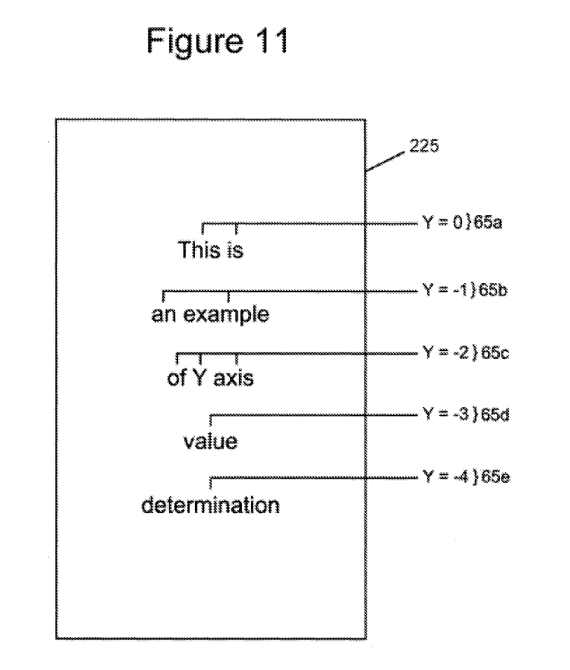

Pre-digestion of the Publisher Fingerprints 212 includes compiling a character/word list of a Page 225 of interest, and determining the Y-Coordinates 265 of each character/word, as shown in FIG. 11 as 265a-e. This compilation is entered into the e-Catalogue Database 250, and allows for the present System to search for matches—in stages, without having to apply the full methodology, thus providing the Server 240 with an efficiency means.

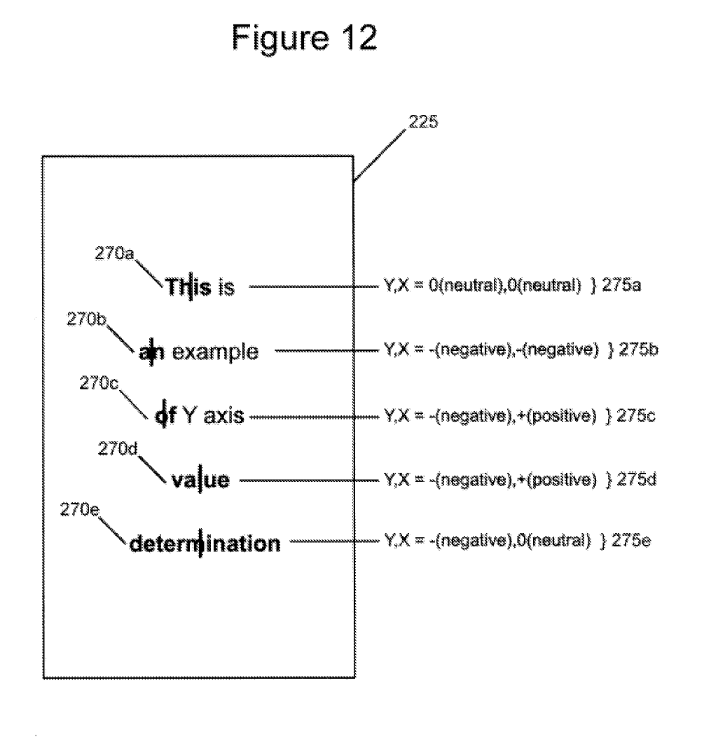

The Publisher Server 240 can further refine the Return Results 340 by calculating the X-Y Relative Coordinates 275a-275e for each of the POC 270a-270e in relation to one another, as shown in FIG. 12. By establishing the polarity of the Relative Coordinates 275a-275e, the Server 240 can further refine the Return Results 340. The Y-axis values can be taken from the determinations made as shown in FIG. 11. The X-axis values are relative to the last POC 270 X-position with the first value always being zero (neutral).

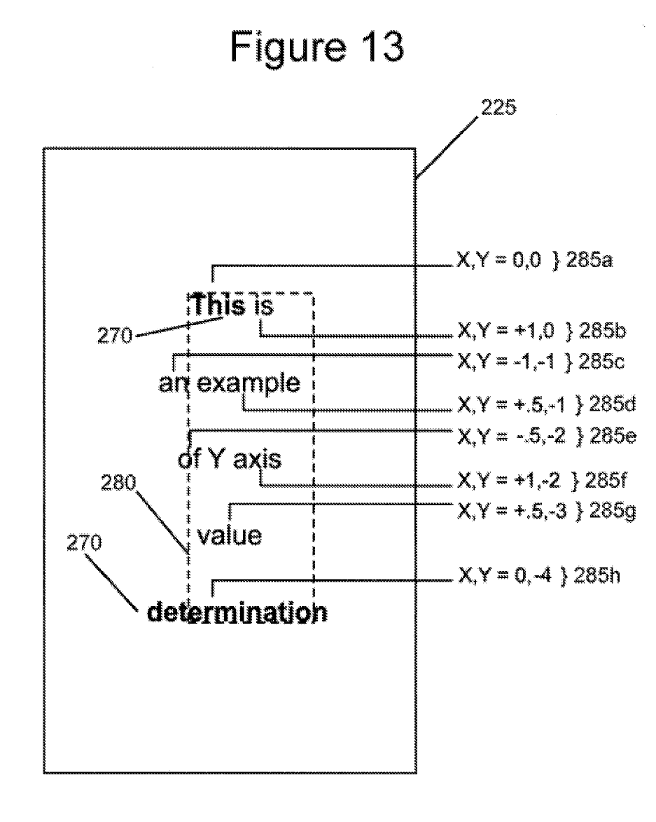

If a Return Result 340 is not conclusive, then additional steps can be taken to further refine the analysis and expand the Return Results 340, see FIG. 13. By establishing the first letter of a first POC 270 and the last letter of a last POC 270, a delimiter can be determined which represents a Pseudo-Edge Box 280. Since the geometry of the Page 225 can be variable because of circumstance, for example, the User captured the image of the Page 225 while the page was curved as opposed to lying entirely flat. By using a Pseudo-Edge Box 280, the Server 240 can more closely approximate the correct results of the User Device 255 generated User Fingerprint 210. If the system used the true edges of a Page 225, then the accuracy might suffer, as the User Device 255 might not capture the entirety of the Page 225, and thus the captured image has no edge data.

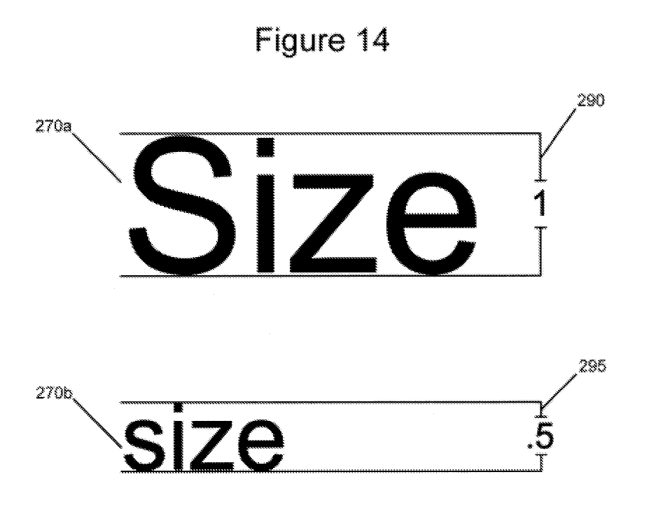

The last step that the Publisher Server 240 can use to refine the Return Results 140 is to determine the Baseline Size 290 of the first POC 270 and compare it to the Relative Size 295 of the rest of the POC 270, see FIG. 14. Size may vary based on font, capitalization, bold or italicized attribute, font size, etc.

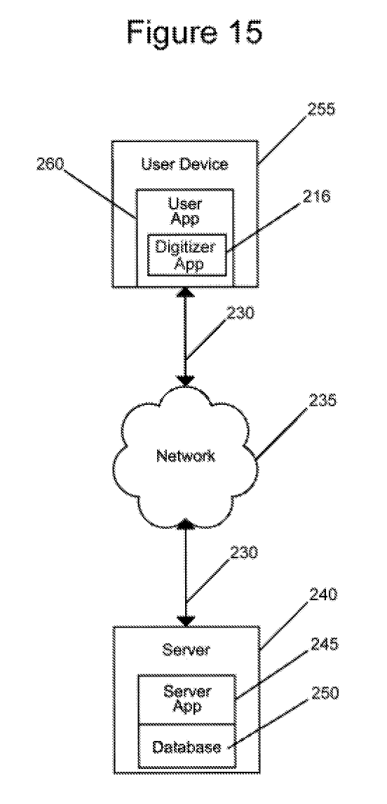

FIG. 15 depicts the User App 260 via the User Device 255 communicating across a Network Connection 230 using a Network 235 to the Publisher Server 240. The Server App 245 can send results from the e-Catalogue Database 250 to the User Device 255. The e-Catalogue Database 250 and the User Device 255 can also exchange information such as payment information, passwords, etc.

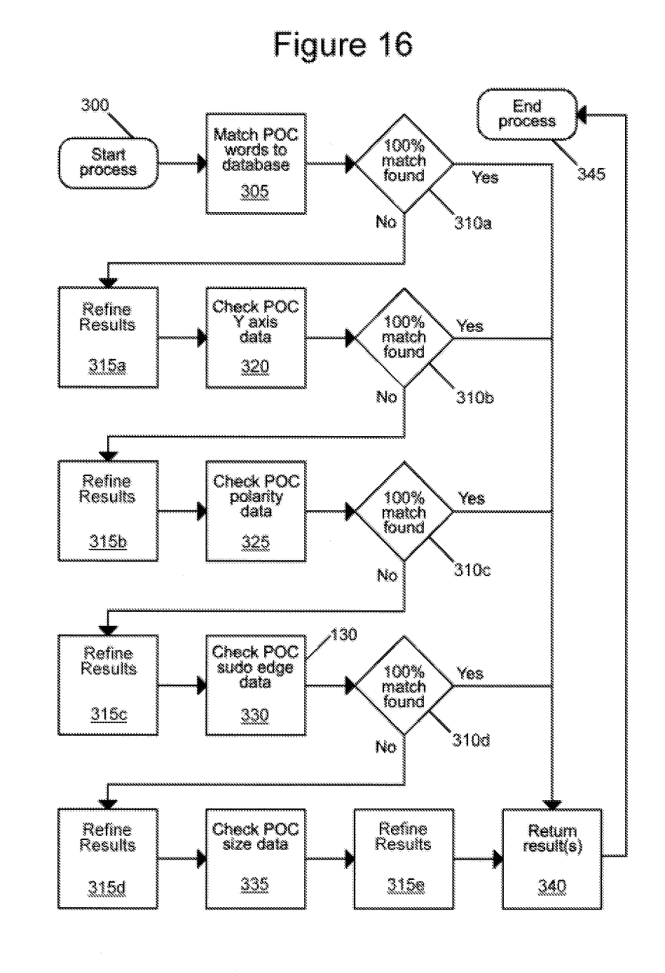

The logic shown in FIG. 16 depicts how the present System can use the information contained in the Publisher Fingerprints 212 of the e-Catalogue Database 250 to establish and process the Return Result 340 data that is sent back to the User Device 255 after a query. The present System will initiate the Fingerprint Matching Process 300 when it receives a User Fingerprint 210 from a User Device 255. The POC 270 characters/words are matched against the e-Catalogue Database 240 of Publisher Fingerprints 212 to see if a high-probability Match Found 310a condition exists. If so then the present System sends a Return Result 340 to the User and an End Process 345 occurs. If a high-probability Match Found 310a condition is not found, alternative analyses are applied: Check POC Y-Axis Data 320, Check POC Polarity Data 325, Check POC Pseudo-Edge Data 330 and lastly Check POC Size Data 335. At each step, the Refine Results 315a-315e queue is filtered, and if a no 100% Match Found 310b-310d condition exists the next step is committed. If a no 100% Match Found 310a-310d condition is found then there will be more than one item in the Return Results 340, which is sent to the User and an End Process 345 occurs.

### Exemplary Use Case

### Pre-Digesting a Fingerprint (Server)

1. Scan page to be fingerprinted
2. Collect OCR data
3. Index all characters/words (a single letter by itself can constitute a word, e.g., the indefinite article “a”) along with their Y-values
   First data found from top to bottom on the same Y-axis is given a value of 0, any additional words found on an equal X-axis are assigned the same Y-axis value of 0
   Next data (single or group) found on a lower Y-axis is given a value of 1, any additional characters/words found on an equal X-axis are assigned the same Y-axis value of 1
   This process continues until all data is assigned a Y-axis value
   If the page contains no alpha-numeric data at all then the finger print data is equal to NULL, which is a valid search criteria
4. This ends the server's pre digestion of the fingerprint data
   All subsequent fingerprinting data (ex. pseudo-edge distance) is calculated on the fly as needed to refine the results

### Establish User Fingerprint (User Device)

1. Process OCR data to establish text
2. Use first letter and last letter found in the OCR data to establish the pseudo-edges of the document.
3. First word or letter (First point of correlation (POC) starting from top left)
   Note the letter or word that is being used
      A single letter, by itself, can constitute a word (e.g., the indefinite article “a”)
   The size of the first letter is the baseline for calculating subsequent size values
   This point is assigned an X-Y value of (0.0)
4. Next character/word or letter on the negative Y-axis
   If no word or character exists on a lower Y-axis then look along the X-axis for a second POC
   When you travel down the Y-axis to find the next POC, increment the Y-axis value by one, any additional POC's found on the same X-axis share the same value Y-axis value
   Note the character/word
   Note if the X and Y value is positive, negative or equal (polarity) in relation to the last point of correlation
   Determine the size difference between the first and second POC
   Continue from step 4 until there are no additional POC found
5. Use the data collected to create fingerprint
   Calculate the POC's relative distance from the pseudo-edge detection.
      The distance is measured from the center of the word or letter to the left pseudo-edge and gives the X-axis value, the Y-axis value is equal to the values assigned in step 4
      The distance from the first point to the left pseudo-edge is the baseline value for distance
   Compile the data created (The pseudo-edge data, the words or letters used as points, points X and Y polarity values, Y-axis data, size data) to create a fingerprint
6. Search local DB* for matches by using the fingerprint data as the search criteria (use same logic as the server fingerprint matching logic diagram)
7. If the fingerprint is blank because there were no POCs, then return results that have no correlation points in their fingerprint
8. If a 100% match is found then return the result
9. If no 100% match is found then return the closest matches ordered by descending % match
10. If no matches were found then return an error message
   * If the DB is not local then send the fingerprint to the applicable server and wait for the results response. Steps 7 through 10 are not applicable if the DB is not local. A server DB may have its own unique set of processes and rules.

### Matching Fingerprints (Server)

1. Receive fingerprint data from User device
2. Extrapolate words (a single letter by itself can constitutes a word, e.g., the indefinite article “a”)
3. Check POC words, in order from top left to bottom right, to see if there is only one 100% match
   If TRUE then return result and end process
   If FALSE, start a match list and proceed to next step
4. Check POC Y-axis data, against match list, to see if there is only one 100% match
   If TRUE then return result and end process
   If FALSE, refine match list and proceed to next step
5. Check POC polarity data, against match list, to see if there is only one 100% match (axis polarity is calculated by subtracting the value of the first and second POC axis values you can determine a polarity of positive, negative or neutral)
   If TRUE then return result and end process
   If FALSE, refine match list and proceed to next step
6. Check pseudo-edge data, against match list, to see if there is only one 100% match (X axis values are determined using the distance from the first POC to the left pseudo-edge as the baseline)
   If TRUE then return result and end process
   If FALSE, refine match list and proceed to next step
7. Check relative size data against match list
   Refine match list and return results

### Note: POC=Points of Correlation

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A system (10) facilitating the purchase of goods and services of others using, the system comprising:
a smart device (12) having a downloadable consumer e-catalog application (14), the smart device (12) in communication with a publisher system server (20), the consumer e-catalogue application (12) including hardcopy page transforming software adapted to transform a content of a hard copy advertisement page to a digitally recognizable content (46) and to transmit the digitally recognizable content (46) via a consumer network connection (18) to the publisher system server (20) in the form of a database query;
the publisher system server (20) having a publisher e-catalogue application (22) and a vendor e-catalog database (50), the publisher system server (20) receives the database query, searches the vendor e-catalog database (50) and responds via the consumer network connection (18) to the consumer smart device (12) with a responsive catalogue content from the vendor e-catalog database (50), the responsive catalogue content related to the recognized content (46) of the database query, and forwards to a vendor of responsive catalogue content a notice of the database query; and
the responsive catalogue content being loaded onto the publisher e-catalog database (50) by the vendor (34) via the vendor network connection (32) and related in the database (50) to the digitally recognizable content (46), so that the responsive catalogue content is linked to and searchable in the vendor e-catalogue database (50) by the related digitally recognizable content (46).

2. A method of participation in a shopping activity between a vendor and a consumer by a third-party computer program (10), the method comprising the steps of:
generating (154) a HCP fingerprint (46) from a printed content of a hardcopy page (70) advertising a consumer item by utilizing a smart device (12) of the consumer having a downloadable HCP transforming and fingerprint generating software (44);
comparing (156) the HCP fingerprint (46) to a vendor e-catalogue database (50) for a corresponding item/entry fingerprint referencing stored vendor/item information related to the consumer item advertised on the hardcopy page (70); and
displaying (160) on the smart device (12) of the consumer, the vendor/item information of the item/entry in the e-catalogue database (50) corresponding to the item/entry fingerprint, and enabling the consumer to purchase (182) the consumer item of the item/entry to facilitate the shopping activity between the vendor and the consumer.

3. A method of participation in a shopping activity between a vendor and a consumer by a third-party computer program (10), the method comprising the steps of:
providing a consumer shopping application (14) having HCP transforming software (44) downloaded onto a consumer smart device (12), the HCP transforming software (44) adapted for viewing and transforming (152) a viewed printed content into an HCP data structure derived from the viewed printed content, for generating (154) an HCP fingerprint (46) from the HCP data structure, and for sending (172) the HCP fingerprint (46) as a data query to a publisher system server (20) via a global communications network (30);
running the publisher system server (20) on the global communications network (30), the publisher system server (20) having a publisher e-catalogue software application (22) and a vendor e-catalog database (50), the publisher system server (20) adapted for receiving (172) the data query from the consumer smart device (12), and comparing (174) the HCP fingerprint (46) of the data query against the vendor e-catalogue database (50) and finding (176) a match between the content of the hardcopy page (70) represented by the HCP fingerprint (46) and a vendor/item entry in the vendor e-catalogue database (50);
replying to the data query by transmitting (178, 180) and displaying (160) the vendor/item entry on the consumer smart device (10) to enable the consumer to browse the vendor/item entry of the vendor e-catalogue database (50) and to initiate a purchase order for an item for sale depicted in the hardcopy advertisement page (70) and in the vendor e-catalogue database (50) by transmitting (182) the purchase order to the publisher system server (20) via the global communications network (30);
receiving and processing (184) the purchase order by the publisher e-catalogue application at the system server (20); and
outputting (184) the purchase order for the item for sale to a vendor (34) of the vendor/item entry in the vendor e-catalogue database (50) to complete (188) the shopping activity between the vendor and the consumer.

4. The method of claim 3, wherein the step of running the publisher system server (20) comprises:
running a publisher system server (20) on the global communications network (30), the publisher system server (20) having a publisher e-catalogue software application (22) and a vendor e-catalog database (50) containing a vendor/item entry, the vendor/item entry having an ID content, a vendor information content and an item for sale content, and the publisher system server (20) adapted for receiving (172) the data query from the consumer smart device (12), and comparing (174) the HCP fingerprint (46) of the data query against the vendor e-catalogue database (50) and finding (176) a match between the content of the hardcopy page (70) represented by the HCP fingerprint (46) and a vendor/item entry in the vendor e-catalogue database (50).

5. An Image Fingerprint Processing System for receiving an image fingerprint (210) generated from a hardcopy page (225) and matching the image fingerprint (210) to an Publisher fingerprint (212) stored in a e-Catalogue Database (250), the System (5) comprising:
a Publisher Server (240), the Publisher Server (240) being a digital processing device having the functionality of a computer server and being connectable to a global computer network (235);
a Publisher Software Application (245), the Publisher Software Application (245) being software resident on and operable on the Publisher Server (240), and adapted to receive and store Publisher fingerprints (212) and associated Vendor Item information (214) in the e-Catalogue Database (250), and to compare an image fingerprint (210) from an item query to Publisher fingerprints (212) in the e-Catalogue Database (250) to generate a match result (340);
an input port on the Publisher Server (240) adapted to receive the item query from a remote User Device (255), and to input the item query into the Publisher Application (245), which item query includes the image fingerprint (210); and
an output port on the Publisher Server (240) adapted to receive the match result (340) from the Publisher Application (245) and to transmit it to the remote User Device (255), these features in combination providing the System for receiving and matching said image fingerprint (210) to said Publisher Fingerprint (212) stored in said e-Catalogue Database (250).
